(19) United States
(12) Patent Application Publication
(10) Pub. No.: US 2013/0117417 A1
(43) Pub. Date: May 9, 2013

(54) Data Transmission System, Method for Transmitting Data Using the Same and Computer-Readable Storage Medium Storing Program for Executing the Method

(71) Applicants: Rick C.S. Chen, Kaohsiung City (TW); Yen-Wen Huang, New Taipei City (TW); Chung-Ting Kao, Taipei City (TW); Hui-Kuang Chung, Taipei City (TW); Han-Chao Lee, Taipei City (TW)

(72) Inventors: Rick C.S. Chen, Kaohsiung City (TW); Yen-Wen Huang, New Taipei City (TW); Chung-Ting Kao, Taipei City (TW); Hui-Kuang Chung, Taipei City (TW); Han-Chao Lee, Taipei City (TW)

(73) Assignee: INSTITUTE FOR INFORMATION INDUSTRY, Taipei (TW)

(21) Appl. No.: 13/437,053

(22) Filed: Apr. 2, 2012

(30) Foreign Application Priority Data
Nov. 8, 2011 (TW) 100140762

(51) Int. Cl. G06F 15/16

(52) U.S. Cl. 709/219

(57) ABSTRACT

A method for transmitting data includes determining which one server has sufficient bandwidth to transmit data packets by a management module when the server needs to transmit the data packets; if the server does not has sufficient bandwidth to transmit the data packets, this server will transmit the data packets to the second one server through a peripheral transmission device; and the second server will receive and transmit the data packets to the Internet by the bandwidth thereof. A data transmission system is disclosed herein.

### RELATED APPLICATIONS

This application claims priority to Taiwan Application Serial Number 100140762, filed Nov. 8, 2011, which is herein incorporated by reference.

### BACKGROUND

1. Field of Invention

The embodiment of the present invention relates generally to electronic communication technique, and, more particularly, to a data transmission system, a method for transmitting data using the system, and a computer-readable medium storing program for executing the method.

2. Description of Related Art

Cloud computing is a computing method based on internet, in which users connects to the data center via internet connection so as to use the internet resources or access personal data. Accordingly, there exists an urgent need to provide a strategy to facilitate the efficient allocation of the bandwidth of the servers of the data center so as to improve the efficiency of the cloud computing.

Currently, there are several solutions to that need. For example, various algorithms have been developed to achieve optimal allocation of bandwidth resources. Methods for dynamically adjusting the configuration of virtual machines (VM) or allowing the bandwidth usage of each physical machine (PM) to exceed the rated bandwidth are also proposed. Also, the hardware architecture may be designed to achieve optimal allocation.

In summary, the existing solutions still have obvious defects and need further improvement. For instance, the algorithms require complicated computation that consumes computing resources; the dynamic adjustment of VM may result in the waste of resources; each PM may not share the bandwidth with one another even though the bandwidth is exceeded; and the hardware architecture requires specific design in each case. In order to solve the above problems, those skilled in the art are trying hard to find a solution, but no suitable method has been proposed.

### SUMMARY

Provided herein are a data transmission system, a method using the data transmission system for transmitting data, and a computer-readable medium storing a program for executing the method, so as to address the problems such as the waste of computing or other resources, the inability to share bandwidths among PMs, the inconvenience of specific hardware design.

Thus, one aspect of the embodiment of the present invention is to provide a method for transmitting data. The method for transmitting data is used in a data transmission system. The data transmission system comprises at least two servers, a peripheral transmitting device, and a management module. The peripheral transmitting device is communicatively connected to the servers and operable to transmit a data packet, and the management module is dispersed in the servers. The method for transmitting data comprises the steps of: determining whether the bandwidth of one server of the servers is sufficient to transmit a data packet by the management module when the data packet of the one server is ready to be transmitted, the one server is operable to transmit the data packet to another server of the servers through the peripheral transmitting device, when the bandwidth of the one server is not sufficient to transmit the data packet; and receiving the data packet by the another server, and transmitting the data packet to the Internet using the bandwidth of the another server.

In another aspect of the embodiment of the present invention, a computer readable storage medium is provided. The computer readable storage medium having stored thereon a computer program which is operable to perform the above-mentioned method for transmitting data. Since the method steps are substantially the same as those described hereinabove, these steps are omitted herein for the sake of brevity.

In yet another aspect of the embodiment of the present invention, a data transmission system is provided. The data transmission system comprises at least two servers, a peripheral transmitting device, a switch, and a management module. Each of the servers comprises a virtual switch module. The virtual switch module provides the bandwidth. The peripheral transmitting device is communicatively connected to the servers and operable to transmit a data packet. The switch is communicatively connected to the virtual switch modules, and the switch receives a fixed bandwidth and distributes the bandwidth to the servers.

Furthermore, the management module is dispersed in the servers. When the data packet of one server of the servers is ready to be transmitted, the management module examines whether the bandwidth of the one server is sufficient to transmit the data packet. When the bandwidth of the one server is not sufficient to transmit the data packet, the one server transmits the data packet to another server of the servers by the peripheral transmitting device, and the another server receives the data packet and transmits the data packet to the Internet by the bandwidth of the another server.

In one embodiment of the system and method of the present invention, when the number of the servers is plural and the bandwidth of the one server is not sufficient to transmit the data packet, the one server transmits the data packet to a server having residual bandwidth of the servers by the peripheral transmitting device, and the server having residual bandwidth of the servers receives the data packet and transmits the data packet to the Internet by the bandwidth of the server having residual bandwidth of the servers.

In yet another embodiment of the present invention, the peripheral transmitting device, as in the present disclosure system and method, comprises a hub. The hub is operable to communicatively connect the servers. The one server transmits the data packet to the server having residual bandwidth of the servers by the hub.

In still another embodiment of the system and method of the present invention, when the bandwidth of the one server is not sufficient to transmit the data packet, the management module examines whether the bandwidth of the another server is sufficient to transmit the data packet, and the one server transmits the data packet to the another server by the peripheral transmitting device when the bandwidth of the another server is sufficient to transmit the data packet.

In yet another embodiment of the system and method of the present invention, the data packet is selected from the group consisting of an input packet and an output packet. When the another server determines that the data packet is the output packet, the another server transmits the data packet to the Internet through the bandwidth of the another server, and when the another server determines that the data packet is the input packet, the another server transmits the data packet to the one server through the peripheral transmitting device.

In still another embodiment of the present invention, each of the peripheral transmitting devices, as in the present disclosure system and method, is selected from the group consisting of a universal serial bus (USB) line and a Com port line.

In yet another embodiment of the present invention, the data transmission system, as in the present disclosure system and method, is a cloud system.

In still another embodiment of the present invention, each of the servers, as in the present disclosure system and method, comprises a virtual switch module. The virtual switch module is operable to provide the bandwidth.

In yet another embodiment of the present invention, the data transmission system, as in the present disclosure system and method, further comprises a switch. The switch is communicatively connected to the virtual switch modules of the servers, and the switch receives a fixed bandwidth and distributes the bandwidth to the servers.

In summary, the embodiments of the present invention provide a data transmission system, a method using the data transmission system for transmitting data, and a computer-readable medium storing a program for executing the method. When a borrowing bandwidth server cannot transmit a data packet, a lending bandwidth server is determined that whether the lending bandwidth server has sufficient bandwidth to transmit data packet so that the lending bandwidth server is used to transmit the data packet to Internet. Therefore, there is no need to perform a complicated algorithm by the servers to obtain a disposed device in advance. There is no need to dynamic adjust a disposition of a virtual machine. There is no need to overcommit the bandwidth and to design a specific hardware. Hence, provided herein are a data transmission system, a method using the data transmission system for transmitting data, and a computer-readable medium storing a program for executing the method, so as to employ the data transmission system for distributing the bandwidth resources efficiently with low operation resources.

### BRIEF DESCRIPTION OF THE DRAWINGS

The invention can be more fully understood by reading the following detailed description of the embodiments, with reference made to the accompanying drawings as follows:

FIG. 1 schematically shows a circuit block diagram of a data transmission system according to one embodiment of the present invention.

FIG. 2 schematically shows a circuit diagram of data transmission system according to an embodiment of the present invention.

FIG. 3A schematically shows a flow diagram of a method using the data transmission system for transmitting data according to embodiments of the present invention. FIG. 3B schematically shows a flow diagram of a method using the data transmission system for transmitting data according to embodiments of the present invention.

FIG. 4 schematically shows a flow diagram of a method using the data transmission system for transmitting data according to embodiments of the present invention.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers indicate like components throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used herein, “around,” “about” or “approximately” shall generally mean within 20 percent, preferably within 10 percent, and more preferably within 5 percent of a given value or range. Numerical quantities given herein are approximate, meaning that the term “around,” “about” or “approximately” can be inferred if not expressly stated.

As used herein, the terms “comprising,” “including,” “having,” “containing,” “involving,” and the like are to be understood to be open-ended, i.e., to mean including but not limited to.

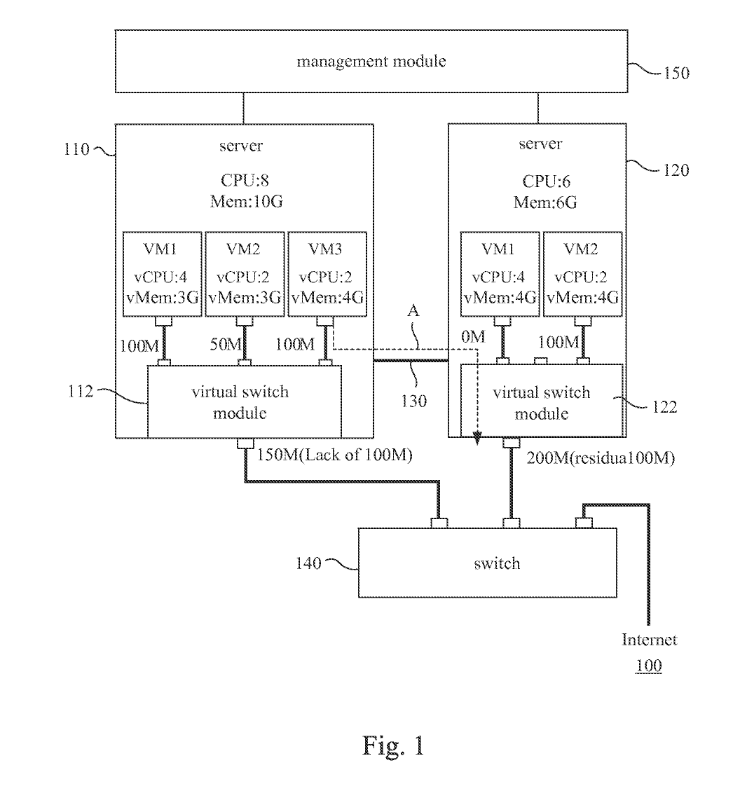

FIG. 1 schematically shows a circuit block diagram of a data transmission system 100 according to one embodiment of the present invention. The data transmitting system 100 comprises at least two servers (for example, server 110 and server 120), a peripheral transmitting device 130, a switch 140, and a management module 150.

As shown in FIG. 1, the server 110 comprises a virtual switch module 112, and the server 120 comprises a virtual switch module 122. The switch 140 is communicatively connected to the virtual switch module 112 and the virtual switch module 122. As shown in the FIG. 1, the server 110 or the server 120 can be a physical machine, the VM1˜VM3 can be virtual machines. Each of the servers and virtual machines thereof can be disposed depending on actual requirements.

For instance, the switch 140 can provide 350M bandwidth, and the switch 140 can distribute 150M bandwidth to the virtual switch module 112 and 200M bandwidth to the virtual switch module 122. However, the scope of the present application is not intended to be limited to the embodiment, it should be understood by those skilled in the art that the total bandwidth of the switch 140, and the bandwidth of the virtual switch module 112 and 122 can be disposed depending on actual requirements.

In addition, the management module 150 can be disposed in the server 110 or the server 120 respectively and can be dispersed in the server 110 and the server 120. The management module 150 can also be a single device which is disposed out of the servers, and the management module 150 is used to examine whether the bandwidth of a server is sufficient to transmit the data packet. However, the present invention is not limited in this regard, and those skilled in the art can dispose the management module 150 depending on actual requirements.

In operation, when the data packet of one server of the servers is ready to be transmitted, the management module 150 examines whether the bandwidth of the one server is sufficient to transmit the data packet. When the bandwidth of the one server is not sufficient to transmit the data packet, the one server transmits the data packet to another server of the servers by the peripheral transmitting device 130, and the another server receives the data packet and transmits the data packet to the Internet through the bandwidth of the another server.

For instance, when the data packet of the server 110 is ready to be transmitted, the management module 150 examines whether the bandwidth of the server 110 is sufficient to transmit the data packet. The switch 140 distributes 150M bandwidth to the virtual switch module 112 of the server 110, and the data packet the server 110 needs to be transmitted is 250M. The value of the data packet the server 110 needs to be transmitted is higher than 150M bandwidth of the virtual switch module 112 so that the bandwidth of the server 110 cannot transmit the data packet.

At this time, the server 110 transmits the data packet to the server 120 by the peripheral transmitting device 130, and the server 120 can transmit the data packet to the Internet through the bandwidth of the server 120. Specifically, when the bandwidth of the VM3 of the server 110 has 100M available bandwidth, the transmission path of the data packet is shown as path A. The data packet is transmitted from the VM3 of the server 110, and the data packet is then transmitted to the server 120 through the peripheral transmitting device 130. The server 120 transmits the data packet to the Internet through the bandwidth of the server 120. In this condition, the server 110 is defined as a borrowing bandwidth server, and the server 120 is defined as a lending bandwidth server for distinguishing different operations of the servers as following.

Hence, the data transmission system 100 of the embodiment of the present invention can employ the management module 150 to examine whether the bandwidth of the server is sufficient to transmit the data packet when the server needs to transmit the data packet. When the server does not have sufficient bandwidth to transmit the data packet, the data packet can be transmitted to another server by the server through the peripheral transmitting device 130. The another server can take the place of the server to transmit the data packet to the Internet. Therefore, there is no need to perform a complicated algorithm by the servers to obtain a disposed device in advance. There is no need to dynamic adjust a disposition of a virtual machine. There is no need to overcommit the bandwidth and to design a specific hardware. Hence, provided herein are a data transmission system 100, so as to employ the data transmission system for distributing the bandwidth resources efficiently with low operation resources.

In one embodiment, the management module 150 examines whether the bandwidth of the lending bandwidth server is sufficient to transmit the data packet when the bandwidth of the borrowing bandwidth server is not sufficient to transmit the data packet. The borrowing bandwidth server will transmit the data packet to the lending bandwidth server through the peripheral transmitting device 130 when the bandwidth of the lending bandwidth server is sufficient to transmit the data packet.

For instance, the management module 150 examines whether the bandwidth of the server 120 is sufficient to transmit the data packet when the bandwidth of the server 110 is not sufficient to transmit the data packet. The server 110 will transmit the data packet to the server 120 through the peripheral transmitting device 130 when the bandwidth of the server 120 is sufficient to transmit the data packet.

In another embodiment, the data packet is selected from the group consisting of an input packet and an output packet. The output packet is the data packet outputted from the borrowing bandwidth server, and the input packet is the data packet which should be returned to the borrowing bandwidth server.

In operation, the lending bandwidth server transmits the data packet to the Internet through the bandwidth of the lending bandwidth server when the lending bandwidth server determines that the data packet is the output packet, and the lending bandwidth server transmits the data packet to the borrowing bandwidth server through the peripheral transmitting device 130 when the lending bandwidth server determines that the data packet is the input packet.

In still another embodiment, the peripheral transmitting device 130 is selected from the group consisting of a universal serial bus (USB) line and a Com port line. That is to say, the peripheral transmitting device 130 can be the universal serial bus (USB) line or the Com port line. However, the present invention is not limited in this regard, and those skilled in the art can selectively adopt any appropriate electrical device which can transmit data for use as the peripheral transmitting device 130.

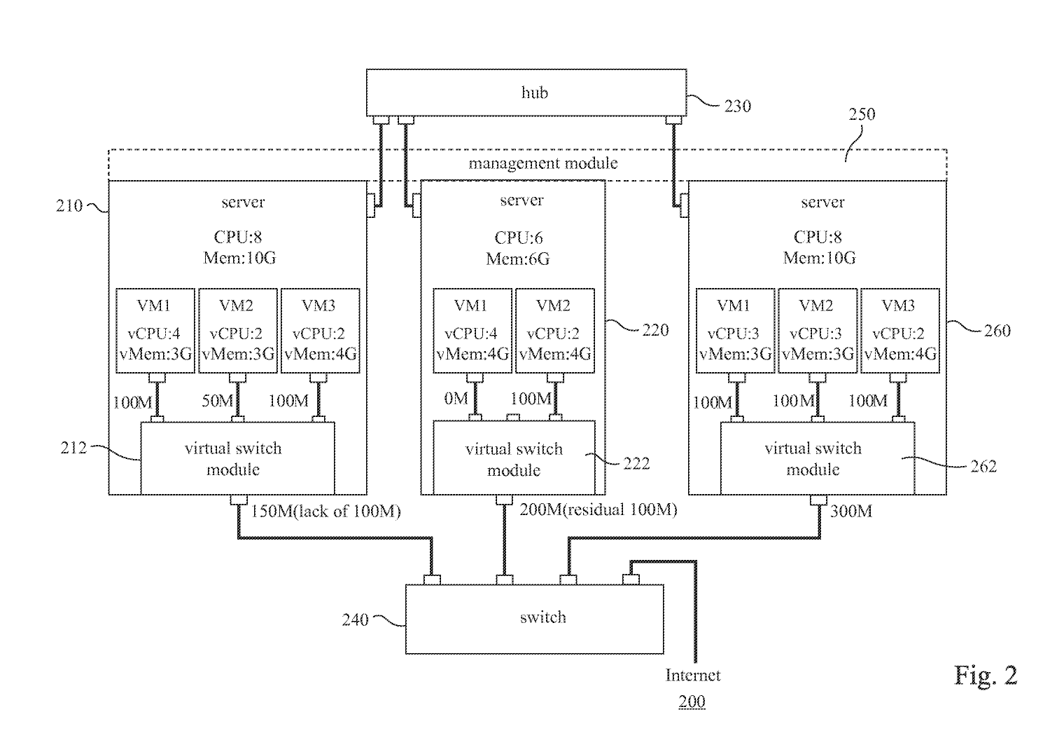

FIG. 2 schematically shows a circuit diagram of data transmission system 200 according to an embodiment of the present invention. The data transmission system 200 comprises a plurality of servers (for example: a server 210, a server 220, and a server 260), a hub 230, a switch 240, and a management module 250.

As shown in FIG. 2, the server 210 comprises a virtual switch module 212, the server 220 comprises a virtual switch module 222, and the server 260 comprises a virtual switch module 262. The switch 240 is communicatively connected to the virtual switch module 212, the virtual switch module 222, and the virtual switch module 262. As shown in the FIG. 2, the server 210, the server 220, or the server 260 can be physical machines, the VM1˜VM3 can be virtual machines. Each of the servers and virtual machines thereof can be disposed depending on actual requirements.

For instance, the switch 240 can provide 650M bandwidth, and the switch 240 can distribute 150M bandwidth to the virtual switch module 212, 200M bandwidth to the virtual switch module 222, and 300M bandwidth to the virtual switch module 262. However, the scope of the present application is not intended to be limited to the embodiment, it should be understood by those skilled in the art that the total bandwidth of the switch 240, and the bandwidth of the virtual switch module 212, 222, and 262 can be disposed depending on actual requirements. In addition, the disposition of the management module 250 is mentioned in the description of FIG. 1, and accordingly, a detailed description regarding the present management module 250 is omitted herein for the sake of brevity.

The one server of the servers transmits the data packet to a server having residual bandwidth of the servers by the hub 230 when the bandwidth of the one server of the servers is not sufficient to transmit the data packet. The server having residual bandwidth of the servers receives the data packet and transmits the data packet to the Internet through the bandwidth of the server having residual bandwidth of the servers.

For instance, when the data packet of the server 210 is ready to be transmitted, the management module 250 examines whether the bandwidth of the server 210 is sufficient to transmit the data packet. The switch 240 distributes 150M bandwidth to the virtual switch module 212 of the server 210, and the data packet the server 210 needs to be transmitted is 250M. Therefore, the bandwidth of the server 210 is not insufficient for 100M bandwidth so that the bandwidth of the server 210 cannot transmit the data packet.

At this time, the management module 250 examines which one of the servers has residual bandwidth, for example, the server 220 has 100M available bandwidth. Therefore, the server 210 transmits the data packet to the server 220 by the hub 230, and the server 220 transmits the data packet to the Internet through the bandwidth of the server 220.

Hence, the data transmission system 200 of the embodiment of the present invention can employ the management module 250 to examine whether the bandwidth of the server is sufficient to transmit the data packet when the server needs to transmit the data packet. When the server does not have sufficient bandwidth to transmit the data packet, the management module 250 examines which one of the servers has residual bandwidth. The server transmits the data packet to the server having residual bandwidth of the servers, and the server having residual bandwidth can take the place of the server to transmit the data packet to the Internet. Therefore, there is no need to perform a complicated algorithm by the servers to obtain a disposed device in advance. There is no need to dynamic adjust a disposition of a virtual machine. There is no need to overcommit the bandwidth and to design a specific hardware. Hence, provided herein are a data transmission system 200, so as to employ the data transmission system for distributing the bandwidth resources efficiently with low operation resources.

It is noted that, the data transmission system 100 and 200 of the embodiment of the present invention can be cloud systems, and the following method 300 and 400 for transmitting data can be implemented in the cloud system.

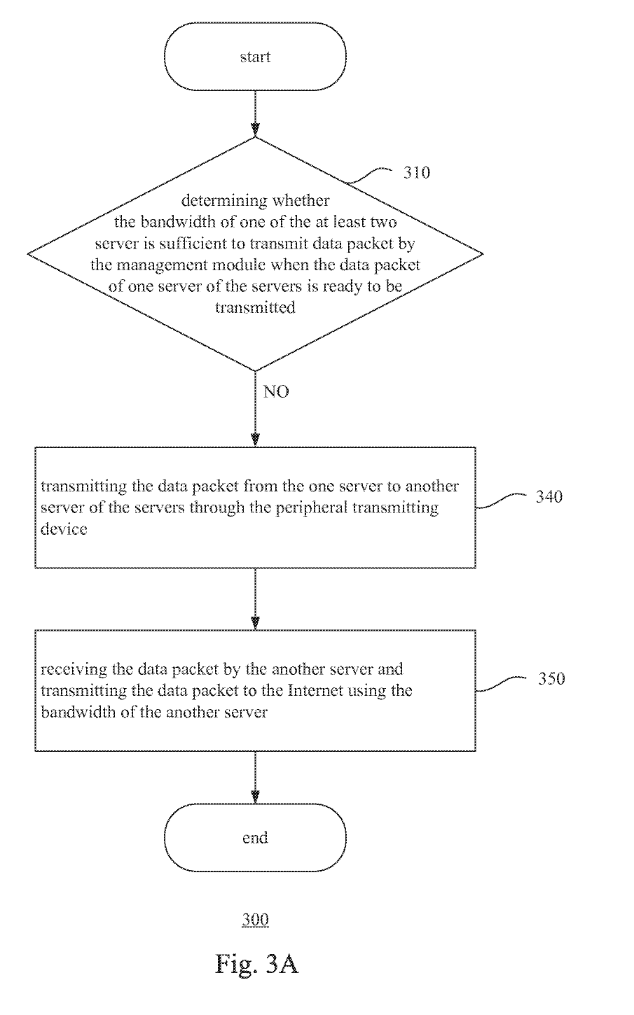

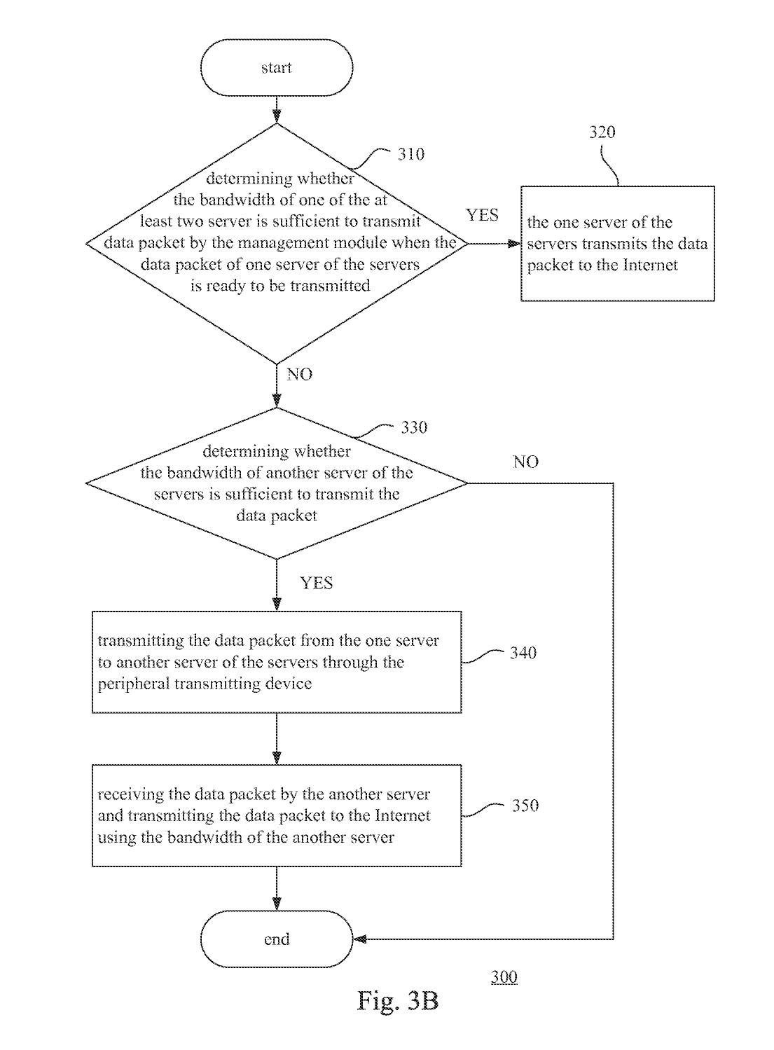

FIG. 3A schematically shows a flow diagram of a method 300 using the data transmission system for transmitting data according to embodiments of the present invention. The method 300 for transmitting data for use in a data transmission system. The data transmission system comprises at least two servers, a peripheral transmitting device, and a management module. The peripheral transmitting device is communicatively connected to the servers and operable to transmit a data packet. The management module is dispersed in the servers.

As shown in FIG. 3A, the method 300 for transmitting data comprises the steps of: determining whether the bandwidth of one of the at least two server is sufficient to transmit data packet by the management module when the data packet of one server of the servers is ready to be transmitted (step 310), transmitting the data packet from the one server to another server of the servers through the peripheral transmitting device, when the bandwidth of the one server is not sufficient to transmit the data packet (step 340); and receiving the data packet by the another server and transmitting the data packet to the Internet using the bandwidth of the another server (step 350).

Reference is now made to both FIGS. 1 and 3A. In step 310, the management module 150 is implemented to determine whether the bandwidth of one of the at least two server is sufficient to transmit data packet.

For instance, as the condition shown in FIG. 1, the management module 150 examines whether the bandwidth of the server 110 is sufficient to transmit the data packet when the data packet of the server 110 is ready to be transmitted.

In step 340, the one server of the servers can transmit the data packet to another server of the servers through the peripheral transmitting device 130, when the bandwidth of the one server is not sufficient to transmit the data packet. Consequently, in step 350, the another server of the servers is implemented to receive the data packet and transmit the data packet to the Internet through the bandwidth of the another server.

For instance, the switch 140 distributes 150M bandwidth to the virtual switch module 112 of the server 110, and the data packet the server 110 needs to be transmitted is 250M. The value of the data packet the server 110 needs to be transmitted is higher than 150M bandwidth of the virtual switch module 112 so that the bandwidth of the server 110 cannot transmit the data packet. At this time, the server 110 transmits the data packet to the server 120 by the peripheral transmitting device 130. The server 120 receives the data packet, and the data packet is transmitted to the Internet through the bandwidth of the server 120.

Hence, the method 300 for transmitting data of the embodiment of the present invention can determine whether the bandwidth of the lending bandwidth server is sufficient to transmit the data packet when the bandwidth provided to the borrowing bandwidth server is not sufficient to transmit the data packet. The lending bandwidth server is implemented to transmit the data packet to the Internet. Therefore, there is no need to perform a complicated algorithm by the servers to obtain a disposed device in advance. There is no need to dynamic adjust a disposition of a virtual machine. There is no need to overcommit the bandwidth and to design a specific hardware. Hence, provided herein are a method 300 for transmitting data, so as to employ the data transmission system for distributing the bandwidth resources efficiently with low operation resources.

FIG. 3B schematically shows a flow diagram of a method 300 using the data transmission system for transmitting data according to embodiments of the present invention. Compared with FIG. 3A, FIG. 3B further comprises step 320 and step 330. Other steps are mentioned in the description of FIG. 3A, and accordingly, detailed descriptions regarding the steps are omitted herein for the sake of brevity.

As mentioned in FIG. 3B, in step 320, the one server of the servers transmits the data packet to the Internet when it is determined that the bandwidth of the one server of the servers is sufficient to transmit the data packet.

Reference is now made to both FIGS. 1 and 3B. For instance, the server 110 transmits the data packet to the Internet when the management module 150 determines that the bandwidth of the server 110 is sufficient to transmit the data packet.

After the step 310 is performed, the management module 150 is implemented to determine whether the bandwidth of another server of the servers is sufficient to transmit the data packet in the step 330 when the bandwidth of the one server of the servers is not sufficient to transmit the data packet. The step 340 is performed when the bandwidth of the another server is sufficient to transmit the data packet.

For instance, the management module 150 is implemented to determine the bandwidth of the server 120 is sufficient to transmit the data packet when the bandwidth of the server 110 is not sufficient to transmit the data packet. The step 340 is performed when the bandwidth of the server 120 is sufficient to transmit the data packet.

In one embodiment, when the data packet of one server of the servers is ready to be transmitted, the management module 150 as shown in FIG. 1 is implemented to examine whether the bandwidth of the one server is sufficient to transmit the data packet. When the bandwidth of the one server is not sufficient to transmit the data packet, the one server transmits the data packet to another server of the servers by the peripheral transmitting device 130, and the another server receives the data packet and transmits the data packet to the Internet through the bandwidth of the another server. The above operation mode is mentioned in the description of FIG. 1, and accordingly, a detailed description regarding the operation mode is omitted herein for the sake of brevity.

In another embodiment, the peripheral transmitting device 130 is selected from the group consisting of a universal serial bus (USB) line and a Com port line. That is to say, the peripheral transmitting device 130 can be the universal serial bus (USB) line or the Com port line. However, the present invention is not limited in this regard, and those skilled in the art can selectively adopt any appropriate electrical device which can transmit data for use as the peripheral transmitting device 130.

It is noted that, the data transmission system of the embodiment of the present invention can be cloud systems, and the above-mentioned method for transmitting data 300 can be implemented in the cloud system.

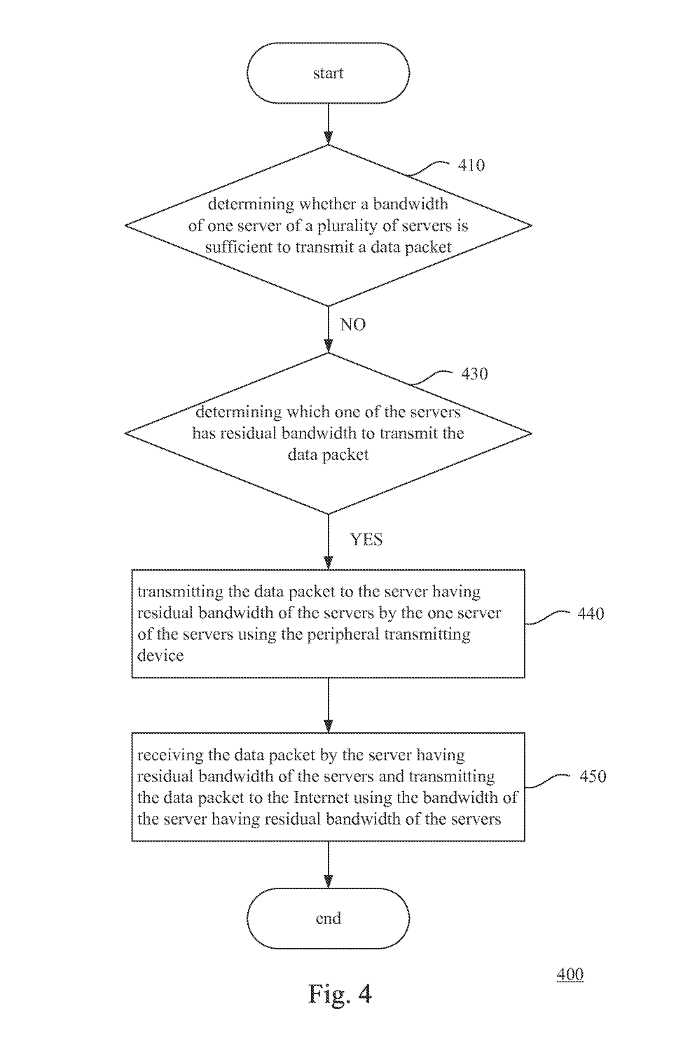

FIG. 4 schematically shows a flow diagram of a method 400 using the data transmission system for transmitting data according to embodiments of the present invention. The method 400 for transmitting data comprises the steps of: determining whether a bandwidth of one server of a plurality of servers is sufficient to transmit a data packet (step 410), if it is determined that the bandwidth of the one server is sufficient to transmit the data packet, determining which one of the servers has residual bandwidth to transmit the data packet (step 430); transmitting the data packet to the server having residual bandwidth of the servers by the one server of the servers using the peripheral transmitting device (step 440); receiving the data packet by the server having residual bandwidth of the servers and transmitting the data packet to the Internet using the bandwidth of the server having residual bandwidth of the servers (step 450).

Reference is now made to both FIGS. 2 and 4. In step 410, the management module 250 is implemented to determine whether the bandwidth of the one server of the servers is sufficient to transmit the data packet.

For instance, as the condition shown in FIG. 2, the management module 250 examines whether the bandwidth of the server 210 is sufficient to transmit the data packet when the data packet of the server 210 is ready to be transmitted.

In step 430, the management module 250 can be implemented to determine which one of the servers has residual bandwidth to transmit the data packet when the bandwidth of the one server of the servers is not sufficient to transmit the data packet.

For instance, the switch 240 distributes 150M bandwidth to the virtual switch module 212 of the server 210, and the data packet the server 210 needs to be transmitted is 250M. The value of the data packet the server 210 needs to be transmitted is higher than 150M bandwidth of the virtual switch module 212 so that the bandwidth of the server 210 cannot transmit the data packet. At this time, the management module 250 can be implemented to determine which one of the servers has residual bandwidth, for example, the server 220 has 100M available bandwidth.

In step 440, the one server of the servers is implemented to transmit the data packet to the server having residual bandwidth of the servers through the hub 230 when it is determined that another server of the servers has residual bandwidth. In step 450, the server having residual bandwidth of the servers is implemented to receive the data packet and transmit the data packet to the Internet by the bandwidth of the server having residual bandwidth of the servers.

For instance, the server 210 transmits the data packet to the server 220 by the hub 230 when the server 220 has 100M available bandwidth. The server 220 receives the data packet and transmits the data packet to the Internet by the bandwidth of the server 220.

It is noted that, the data transmission system 100 and 200 of the embodiment of the present invention can be cloud systems, and the above-mentioned method for transmitting data 300 and 400 can be implemented in the cloud system.

Hence, the method 400 for transmitting data of the embodiment of the present invention can determine whether the bandwidth of the lending bandwidth server is sufficient to transmit the data packet when the bandwidth provided to the borrowing bandwidth server is not sufficient to transmit the data packet. The lending bandwidth server is implemented to transmit the data packet to the Internet. Therefore, there is no need to perform a complicated algorithm by the servers to obtain a disposed device in advance. There is no need to dynamic adjust a disposition of a virtual machine. There is no need to overcommit the bandwidth and to design a specific hardware. Hence, provided herein are a method 400 for transmitting data, so as to employ the data transmission system for distributing the bandwidth resources efficiently with low operation resources.

The method 300 and 400 for transmitting data may take the form of a computer program product stored on a computer-readable storage medium such that the data synchronization method can be implemented after the storage medium is read by the computer. The computer-readable storage medium can be a read only memory (ROM), a flash memory, a floppy disk drive, a hard disk drives (HDD), a compact disk (CD), a USB disk, a magnetic tape, a database which can be read and accessed via Network, or any computer-readable storage medium which can be adopted by those skilled in the art and which has the same functionality. The method 300 and 400 for transmitting data can be implemented by integrating the computer program and more than one processor and chip.

Those having skill in the art will appreciate that the method 300 and 400 for transmitting data can be performed with software, hardware, and/or firmware. For example, if an implementer determines that speed and accuracy are paramount, the implementer may opt for a mainly hardware and/or firmware implementation; alternatively, if flexibility is paramount, the implementer may opt for a mainly software implementation; or, yet again alternatively, the implementer may opt for some combination of hardware, software, and/or firmware. Those skilled in the art will recognize that optical aspects of implementations will typically employ optically oriented hardware, software, and or firmware.

In addition, those skilled in the art will appreciate that each of the steps of the method 300 and 400 for transmitting data named after the function thereof is merely used to describe the technology in the embodiment of the present invention in detail rather than limiting the present invention. Therefore, combining the steps of said method into one step, dividing the steps into several steps, or rearranging the order of the steps is within the scope of the embodiment in the present invention.

In view of the foregoing embodiments of the present disclosure, it is contemplated that the present disclosure has the advantages as follows. Provided herein are a data transmission system, a method using the data transmission system for transmitting data, and a computer-readable medium storing a program for executing the method, so as to address the problems such as the waste of computing or other resources, the inability to share bandwidths among PMs, the inconvenience of specific hardware design.

The embodiments of the present invention provide a data transmission system, a method using the data transmission system for transmitting data, and a computer-readable medium storing a program for executing the method. When a borrowing bandwidth server cannot transmit a data packet, a lending bandwidth server is determined that whether the lending bandwidth server has sufficient bandwidth to transmit the data packet so that the lending bandwidth server is used to transmit the data packet to Internet. Therefore, there is no need to perform a complicated algorithm by the servers to obtain a disposed device in advance. There is no need to dynamic adjust a disposition of a virtual machine. There is no need to overcommit the bandwidth and to design a specific hardware. Hence, provided herein are a data transmission system, a method using the data transmission system for transmitting data, and a computer-readable medium storing a program for executing the method, so as to employ the data transmission system for distributing the bandwidth resources efficiently with low operation resources.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention, and the scope thereof is determined by the claims that follow.

What is claimed is:

1. A method for transmitting data in a data transmission system, the data transmission system comprising at least two servers, a peripheral transmitting device, and a management module, wherein the peripheral transmitting device is communicatively connected to the servers and operable to transmit a data packet, and the management module is dispersed in the servers, wherein the method for transmitting data comprises:
determining whether the bandwidth of one server of the servers is sufficient to transmit the data packet to the Internet by the management module when the data packet of the one server is ready to be transmitted;
operable transmitting the data packet from the one server to another server of the servers through the peripheral transmitting device, when the bandwidth of the one server is not sufficient to transmit the data packet; and
receiving the data packet by the another server, and transmitting the data packet to the Internet using the bandwidth of the another server.

2. The method for transmitting data according to claim 1, wherein when the number of the servers is plural and the bandwidth of the one server is not sufficient to transmit the data packet, the method for transmitting data further comprises:
the one server transmitting the data packet to a server having residual bandwidth of the servers by the peripheral transmitting device; and
receiving the data packet by the server having residual bandwidth of the servers, and transmitting the data packet to the Internet by the bandwidth of the server having residual bandwidth of the servers.

3. The method for transmitting data according to claim 2, wherein
the peripheral transmitting device comprises a hub which is configured to communicatively connect the servers, and
the one server transmits the data packet to the server having residual bandwidth of the servers through the hub.

4. The method for transmitting data according to claim 1, wherein when the bandwidth of the one server is not sufficient to transmit the data packet, the management module examines whether the bandwidth of the another server is sufficient to transmit the data packet, and the one server transmits the data packet to the another server by the peripheral transmitting device when the bandwidth of the another server is sufficient to transmit the data packet.

5. The method for transmitting data according to claim 1, wherein the data packet is selected from the group consisting of an input packet and an output packet, when the another server determines that the data packet is the output packet, the another server transmits the data packet to Internet through the bandwidth of the another server, and when the another server determines that the data packet is the input packet, the another server transmits the data packet to the one server through the peripheral transmitting device.

6. The method for transmitting data according to claim 1, wherein the peripheral transmitting device is selected from the group consisting of a universal serial bus (USB) line and a Com port line.

7. The method for transmitting data according to claim 1, wherein when the bandwidth of the one server is determined that the bandwidth of the one server is sufficient to transmit the data packet, the one server transmits the data packet to Internet.

8. The method for transmitting data according to claim 1, wherein the data transmission system is a cloud system.

9. A computer readable storage medium having stored thereon a program executable to perform a method for transmitting data in a data transmission system, and the data transmission system comprises at least two server, a peripheral transmitting device, and a management module, wherein the peripheral transmitting device is communicatively connected to the servers and operable to transmit a data packet to Internet, and the management module is dispersed in the servers, wherein the method for transmitting data comprises:
determining, when the packet from one server of the servers is to be transmitted to the Internet, whether the bandwidth of the one server is sufficient to transmit the data packet by the management module,
the one server operable to transmit the data packet to another server through the peripheral transmitting device if the bandwidth of the one server being not sufficient to transmit the data packet; and
receiving the data packet by the another server, and transmitting the data packet to Internet by the bandwidth of the another server.

10. A data transmission system, comprising:
at least two servers;
a peripheral transmitting device communicatively connected to the servers and operable to transmit a data packet; and
a management module dispersed in the servers, wherein when the data packet of one server is ready to be transmitted, the management module examines whether the bandwidth of the one server is sufficient to transmit the data packet,
wherein when the bandwidth of the one server is not sufficient to transmit the data packet, the one server transmits the data packet to another server by the peripheral transmitting device, and the another server receives the data packet and transmits the data packet to the Internet using the bandwidth of the another server.

11. The data transmission system according to claim 10, wherein when the number of the servers is plural and the bandwidth of the one server is not sufficient to transmit the data packet, the one server transmits the data packet to a server having residual bandwidth of the servers by the peripheral transmitting device, and the server having residual bandwidth of the servers receives the data packet and transmits the data packet to Internet by the bandwidth of the server having residual bandwidth of the servers.

12. The data transmission system according to claim 11, wherein the peripheral transmitting device comprises:
a hub operable to communicatively connect the servers, wherein the one server transmits the data packet to the server having residual bandwidth of the servers through the hub.

13. The data transmission system according to claim 10, wherein when the bandwidth of the one server is not sufficient to transmit the data packet, the management module examine whether the bandwidth of the another server is sufficient to transmit the data packet, and the one server transmits the data packet to the another server by the peripheral transmitting device if the bandwidth of the another server is sufficient to transmit the data packet.

14. The data transmission system according to claim 10, wherein the data packet is selected from the group consisting of an input packet and an output packet, when the another server determines that the data packet is the output packet, the another server transmits the data packet to Internet through the bandwidth of the another server, and when the another server determines that the data packet is the input packet, the another server transmits the data packet to the one server through the peripheral transmitting device.

15. The data transmission system according to claim 10, wherein each of the peripheral transmitting devices is selected from the group consisting of a universal serial bus (USB) line and a Com port line.

16. The data transmission system according to claim 10, wherein the data transmission system is a cloud system.

17. The data transmission system according to claim 10, wherein each of the servers comprises:
a virtual switch module operable to provide the bandwidth.

18. The data transmission system according to claim 17, further comprising:
a switch communicatively connected to the virtual switch modules of the servers, wherein the switch receives a fixed bandwidth and distributes the bandwidth to the servers.
